(19) United States
(12) Patent Application Publication
(10) Pub. No.: US 2017/0237822 A1
(43) Pub. Date: Aug. 17, 2017

(54) Third Party Sponsored Short Messaging Service

(71) Applicant: Ari Kahn, Mount Shasta, CA (US)

(72) Inventor: Ari Kahn, Mount Shasta, CA (US)

(21) Appl. No.: 15/044,101

(22) Filed: Feb. 15, 2016

(51) Int. Cl. H04L 29/08; H04W 4/24; H04W 4/12

(52) U.S. Cl. CPC H04L 67/2804; H04W 4/12; H04L 67/20; H04W 4/24

(57) ABSTRACT

The methods and systems disclosed herein, enable mobile communications operators to modify and reposition the SMS messaging platform by allowing users to send SMS messages sponsored by third party content that tags along with the original user content. An example of the method comprises: a) receiving at an intermediary network service node, a mobile originating message from a first user on a first telephony device, addressed to a second user on a second telephony device; b) modifying the content of the original message to include additional third party text; and c) sending the modified message to the second user on the second telephony device. In a variant of the method, the original text message content is replaced with an Internet uniform resource locator (URL) referencing the original text content.

### FIELD OF INVENTION

The subject matter relates to systems and methods for transforming the legacy SMS Short Messaging Service, from a closed, private communications channel into an open, third party sponsored mobile advertising platform.

### BACKGROUND

SMS utilization has come under severe pressure from highly competitive and free OTT (Over The Top) messaging applications, resulting in dramatically declining use and consequential decrease in Carrier revenue. The Legacy Wireless Short Messaging Service, which is transported over the SS7 network, is typically billed per messageand has become an expensive alternative to the “almost free” OTT alternatives, which utilize Internet Protocols to deliver messages. While OTT messaging providers typically do not charge users, mobile users are still required to pay the Mobile Operator for wireless data service, in order to transport messages.

Since text messagingincurs a small data payload, OTT message delivery cost to users is marginal, especiallywhen compared to legacySMS and to broadband data services such as video and voice. However, the biggest gap in service is between one that is completely free, and one that costs a “penny”. Since the native SMS application and functionality is embedded in practically every mobile phone, and since SMS messages are addressed using the standard contact telephone number, SMS is a ubiquitous technology that still remains a viable communications channel if it can be adapted to compete effectively with new generation IP messaging services.

This disclosure teaches how to seamlessly transform the Legacy SMS service from a private and closed, person to person messaging service, into an opencompetitive third party sponsored advertising platform, allowing users to freely send personal messages without incurring cost whilst generating new message based advertising revenue streams for Carriers.

### BRIEF DESCRIPTION OF THE DRAWINGS

FIG. 1A is a network abstraction depicting the newly disclosed Third Party sponsored content modification to a mobile originating SMS message.

FIG. 1B is a network abstraction depicting the newly disclosed Linked Message Modification to a mobile originating SMS message.

FIG. 1C is a network abstraction depicting a two staged SMS delivery architecture supporting the disclosed systems and methods via attendant IP nodes.

FIG. 2 is a series of flow diagrams highlighting the key logical decision points in the disclosed modified mobile SMS messaging service.

FIG. 3 is a step ladder illustrating core logical nodes in the modified SMS service transporting third party sponsored content.

FIG. 4 is a step ladder illustrating core logical nodes in the Link Modified SMS service encapsulating original content.

FIG. 5 is a step ladder illustrating SMS content modification via an External SMS Service Entity.

Skilled mobile networking artisans will appreciate, that while the diagrams are simplified they are nonetheless explicit and instructive, and serve to highlight the key aspects of the present invention without having to depict all mobile network elements and steps that are well known in the art. Some elements in the drawings are illustrated for simplicity and clarity and have not necessarily been drawn to scale. The dimensions of some of the elements in the figures may be exaggerated, relative to other elements. Some steps are condensed and others are omitted to improve understanding of the embodiments of the present invention.

Further it will be appreciated that some elements in the diagrams are simply commentary, annotating key events. For example, “tags” (italicized text in dotted outlines). These tags placed within step ladder figures, while positioned between lines connecting network elements (A MSC SMSC DB/AD B), are not intended to logically connect these network nodes nor are they originating from the said nodes. These tags serve simply to highlight said events.

### Glossary of Terms

A: The Originating Mobile User/Device

B: The Terminating Mobile User/Device

AO: Application Originating

AT: Application Terminating

ASCII: American Standard Code for Information Interchange

AD: Advertisement

CDMA: Code Division Multiple Access

DB: Database

DNS: Domain Name Service

ENUM: Enumerated

ESME: External Short Message Entity

GSM: Global Systems Mobile

HTML: Hyper Text Markup Language

IP: Internet Protocol

ITC: In The Channel

LTE: Long Term Evolution

MO: Mobile Originating

MT: Mobile Terminating

MMS: Multimedia Messaging Service

MMSC: MMS Center

MSISDN: Mobile Station International Subscriber Directory Number

OTT: Over The Top

SMPP: Short Message Peer to Peer

SMS: Short Message Service

SMSC: SMS Center

SS7: Signaling System Seven

TDMA: Time Division Multiple Access

WWW: World Wide Web

### BRIEF SUMMARY OF THE EMBODIMENTS OF THE INVENTION

The current state of the SMS art delivers a mobile originating SMS to a mobile terminating device, exactly as constructed by the sender, “character for character”, since up to now SMS has been distinguished as a private communications channel paid for exclusively by users. While SMS is addressed “peer to peer,” it is delivered by the Mobile Operator Network via an intermediary Messaging Service Center (SMSC) which affords the Operator the opportunity to seamlessly inject third party content into the original message, before transmitting the message to the addressed destination, and to thereby differentiate and evolve the service offering.

The methods and systems disclosed herein, enable Mobile Operators to modify and reposition the SMS messaging platform by allowing users to send SMS messages sponsored by third party content that tags along with the original user content. By shifting cost to third party advertisers, mobile operators can galvanize legacy wireless SMS messaging, transforming it into a lucrative In The Channel (ITC) advertising platform that can effectively compete with OTT messaging services.

Delivering new capability in the channel, leverages existing mass communication capabilities. Unlike OTT, ITC does not require users to download and install third party applications on their mobile device, since ITC operates using native functionality embedded in the mobile device, in particular telephony and texting. ITC may be termed, “zero distribution service,” since the capability already exists on the device, and therefore does not require new software distribution. There is tremendous value in advertisers linking directly into an existing mass, peer to peer, user messaging stream, and for users being able to message the world at no cost.

Unlike unsolicited SMS marketing, which is perceived as spam and is universally detested, the advertising content in the current disclosure is distinguished in that it is transported along with personal message content. This dual messaging container, which in the exemplary embodiment carries a personal message free from charge, together with a third party paid for message, is a free, sponsored and socially congruent service.

In analogy to the Internet header advertising banner, the sponsored SMS message as disclosed, becomes the new advertising footer, that foots the SMS bill. In the exemplary embodiment, the Sponsor pays for the SMS service in its entirety enabling users to send SMS at zero cost. In an alternative embodiment, the SMS carrier reduces all peer to peer mobile originating and terminating SMS costs to, for example, a penny, compensating with revenue gain from third party advertisers.

“Third Party” in the context of this disclosure, is in relation to the First Party (A), the mobile SMS originator and the Second Party (B), the mobile terminating recipient of the SMS message. Originating SMS message content, refers to the personal message, as constructed by the original sender A, transported via the SMS protocol.

While this disclosure teaches how to transform the GSM SMS service, it may similarly transform equivalent CDMA and LTE based messaging services and MMS (Multimedia Messaging) Services. Further, while the disclosure is based on the 160 character (140 byte) messaging service as defined by the Standard SMS protocol, it may equally be applied to what is well known in the art as the Concatenated SMS protocol which permits messages greater than 160 characters in length. SMS, concatenated SMS and MMS are thus interchangeable in the context of this disclosure.

In the concatenated SMS embodiment, the systems and methods described would typically modify the first message portion to display the third party text. Further, while the disclosure references the standard ASCII character set, different maximum message length thresholds, applicable to calculating the maximum permissible message length in order to create space to append the third party sponsored text, may vary with differently encoded character sets, that are typically used when sending foreign, non English, messages.

In a preferred embodiment, the SMS received from the originator is limited to 100 characters, permitting the Mobile Operator to append up to a 60 character third party sponsored text advertisement. In the preferred embodiment, this message length limitation is implemented on the network side, so as to preserve legacy messaging functionality embedded in mobile devices. In one embodiment, the sponsored text is plain ASCII text, which is visible without requiring any additional user interaction and mobile device functionality, such as having to activate a link which in turn launches an Internet Browser. For example:

[Original SMS]: From A To B: “Hello”

[Modified SMS]: From A To B: “Hello <This is advertising text . . . >”

In the preferred embodiment, at least one blank line separates the personal content from the third party content. In the preferred embodiment, where the original message is displayed together with the third party message, the SMS message source maintains the originating mobile user identity (MSISDN A) so as to match a personally recorded contact in the B mobile address book.

In a preferred embodiment, the sponsored text includes a text link URL (Uniform Resource Locator). The URL enables the recipient to activate (“click” or “tap”) the link to direct the mobile device to the associated Internet location, where additional third party content may then be displayed on the mobile device, for example:

[Original SMS]: From A To B: “Hello”

[Modified SMS]: From A To B: “Hello <www.abc.com/ . . . >”

In yet a further embodiment, the entire original SMS message content is replaced with a text URL, that notifies the recipient that a new message is pending retrieval, and that references and displays the original content, online when the URL link is activated. On activation, the said URL then displays the original message content together with third party sponsored content, for example:

[Original SMS]: From A To B: “Hello”

[Modified SMS]: From A To B: “New message@ www.abc.com/B”

In the above example, the entire original message is replaced by a URL which is then delivered to the recipient via SMS as a message notification. In this embodiment, on activating the link, the recipient is directed to an associated web page which can display third party content in addition to revealing the original message content sent to the recipient.

In one such linked message embodiment, the message delivered displays the sending user's mobile address (MSISDN A), which is typically known to the recipient. Being a personally addressed message encourages the recipient to click the link in order to read the referenced message, since knowing the sender imparts link trust. In an alternate presentation, the source address of the message displaying the URL may be a generic carrier supplied address. The recipient is then generically notified of new messages pending and is enticed to activate the link in order to read the original message(s) online for example:

[Original SMS]: From A To B: “Hello”

[Modified SMS]: From XXX To B: “New message(s) @ www.abc.com/B”

The advantage in displaying a URL, which references the original message content, is the link opens the browser to render a rich, easily stylized display. In such a linked messaging service, all third party sponsored content is referenced and incorporated using well known markup languages such as HTML, where said sponsored content is simply linked to the displayed page and sourced from well known advertising platforms and agencies. Once such well known advertising agency and platform is Google AdSense.

Further, displaying a URL that replaces and references the original message, in addition to being able to display richer third party content, can consolidate all messages to a recipient in an online message inbox, complete with message history. The messaging inbox is a well known metaphor, where all messages to a said recipient are listed and accessible from a central location.

In such a linked inbox embodiment, the link then identifies the online inbox rather than necessarily identifying any specific message individually. By referencing a collection of messages rather than an individual message instance, the linked SMS embodiment abstracts the messaging service into a new IP messaging platform that is stored in the cloud and accessed via an associated link.

In a preferred linked inbox embodiment, the system and methods described may consolidate link delivery and new message notifications to the recipient, in order to reduce notification costs, since SMS text delivery typically incurs a terminating charge. This terminating charge is particularly relevant when the originating network is distinct from the terminating network, that is when the recipient is “off net” (on a different network to the sender).

In one such consolidated delivery notification system, the recipient is typically notified once, when a new message is received, rather than repeatedly notified with each new message received. Such a consolidated notification may present as described above (where/number is the recipient mobile telephone number):

“New message(s) @ www.abc.com/15551234567”.

In such an optimized notification embodiment, the messaging system typically suspends further notification until such time as the recipient activates the link. Further, since the messaging system can determine whether the recipient is currently viewing the link associated message inbox, all new messages received may alert the user online, via the inbox, rather than out of band via a new SMS message, which incurs signaling cost. When the user exits the online inbox, SMS notification may then once again resume, when a new message has been received.

This online versus offline notification system may be described as being controlled by what is well known to suitably skilled software artisans, as a semaphore, the semaphore being raised (notification suspended) when the recipient is online, and lowered (notification resumed) when the recipient is offline.

The said linked messaging inbox delivers desirable message extensions to the conventional SMS messaging service. By storing all messages online, in the cloud, the disclosed linked messaging service delivers a single central message repository accessible from any device. Users may also reply to messages directly from the inbox applying the disclosed message modifications online, rather than having to construct an SMS message via the native SMS application on the mobile device.

Access to the universal sponsored wireless messaging inbox, may be via a simple personalized URL, identifying the recipient by their mobile telephone number, for example:

www.abc.com/15551234567

15551234567.abc.com

7.6.5.4.3.2.1.5.5.5.1.abc.com

The last example above, describes the recipient mailbox on an ENUM DNS URL, which suitably skilled networking artisans will appreciate, reverse maps the E.164 telephone number space (MSISDN B) into the DNS space, permitting the “abc.com” domain to scale dramatically on delegating access anywhere along the numerical dotted path.

On accessing such a centralized SMS inbox for the first time, the user may be prompted to verify their mobile telephone number, using well known two factor authentication. Once such two factor authentication would send an SMS access code to the identified telephone number, and only permit access to the online SMS inbox on the user typing the same said SMS code into the online SMS inbox page. Once authenticated, the user may elect to password protect the online SMS inbox for additional security.

The linked messaging service embodiment, which delivers a link to the original text message rather than delivering the original message, in full or in part, transforms the standard SMS messaging channel from a plain ASCII text format to a rich HTML text format, since clicking the said link opens the associated Internet browser on the recipient mobile device, to render a stylized web page containing the original text message.

As is well understood in the art, HTML and similar markup languages, permit the rendering of stylized and formatted content, including text, images, video and other media formats. Presenting the recipient with a link to richer messaging content delivers an enhanced messaging experience.

In one embodiment, the third party content may be presented as a plain text and URL mixture, where a short description of the sponsoring URL is included. Further, to stimulate user adoption of such a third party sponsored URL service, carriers may zero rate (send the message without any cost to the user) the primary URL domain (“abc.com” in the above link examples), permitting users to browse the linked address page without having to pay for data consumption.

Typically, URLs are presented as well known short URLs that are redirected to mapped longer URLs, in order to minimize the number of characters required to link to an associated Internet Address. In alternate embodiments, the advertisement may comprise text and telephone numbers, images and other content formats.

While the systems and methods described herein are automatically invoked by the network, in an alternate embodiment, the third party message sponsoring feature may be activated or similarly deactivated under sending user control, to either specifically partake in the free sponsored messaging or to specifically abstain from third party messaging content being appended to their messages.

In one such user invoked messaging service, all SMS messages addressed to a regularly formatted mobile recipient telephone contact number (MSISDN B) are delivered without message content modification, thus preserving the current state of the art. This preserves the SMS messaging service, both with respect to original message content and usage payment.

In order to selectively differentiate from the said state of the messaging content presentation and billing art, the disclosed third party sponsored messaging service may be selectively engaged or disengaged in a preferred embodiment, by prefixing the recipient telephone address with a requisite service symbol or service escape code.

That is, carriers may elect to modify the SMS content for all mobile terminating messages by default, and provide a service escape code prefix to selectively disengage from the said automatic third party sponsored messaging service. Conversely, carriers may elect to preserve SMS content as originally constructed, and provide a service feature code to selectively engage the third party message content modification and sponsorship as disclosed.

In the exemplary prefixed embodiment, a “star” (*) prefix delivers a symbolically addressed service to differentiate such a third party sponsored messaging service. In such a star addressed service, the originating user sends the SMS message to a recipient identified by a “*” followed by the recipient telephone number (*MSISDN B).

On receiving such a star addressed message, the network and attendant messaging nodes, then engages/disengages modifying the message content with third party sponsored content as disclosed. In such a prefix engaged SMS content modification embodiment, notifying a recipient of such a star addressed linked message, may then uniquely brand the service, as follows:

“New star text @www.startxt.com/ . . . ”

Whereas Star (*) is the exemplary symbolically addressed prefix and branded service, other symbolic and numerical prefixes, either alone or in combinations, may achieve the desired result. These prefixes may include without limitation, Star (*), Star Star (**), Pound (#), Pound Pound (##), Star and Pound (*# and #*), Double Zero (00), Star and Pound combinations with or without numeric codes (*XXX and XXX), numeric codes without symbols (00), other non numeric characters (@) and so on.

In any embodiment, the third party content may be programmatically generated and selected, and may be determinant, without limitation on the content of the original message, including the location of the message sender, the location of the message recipient, the source and destination network of the sender and recipient, the message time of day, the length of the original message, the frequency of messages from the sender, the frequency of messages from the sender to the recipient.

A method for delivering third party sponsored text advertising in a Wireless Messaging Service comprises, receiving a mobile originated message from a first user on a first mobile telephony device addressed to a second user on a second mobile telephony device. At an intermediary Messaging Service Node, selectively truncating the original message by reducing the number of characters in the received message to a specified maximum number of characters. Appending a third party text message to the selectively truncated message. Billing the third party for appending the said additional text to the SMS message. Zero rating the original message so as not to debit the first users account with any amount for accepting and delivering the original message and forwarding the newly amended message, which now includes third party content, to the second user device.

### DETAILED DESCRIPTION OF THE EMBODIMENTS OF THE INVENTION

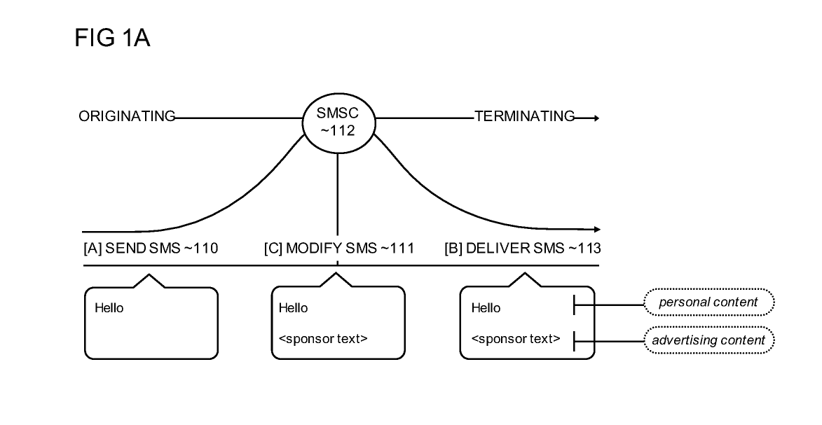

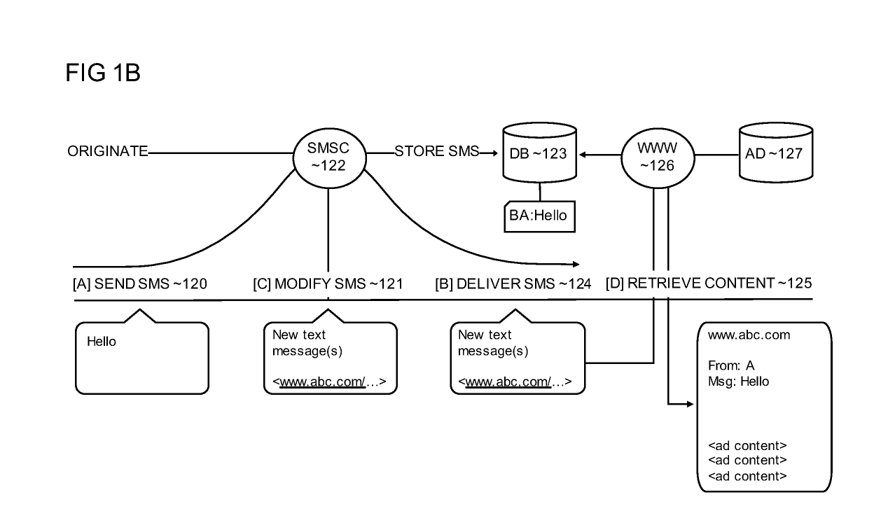

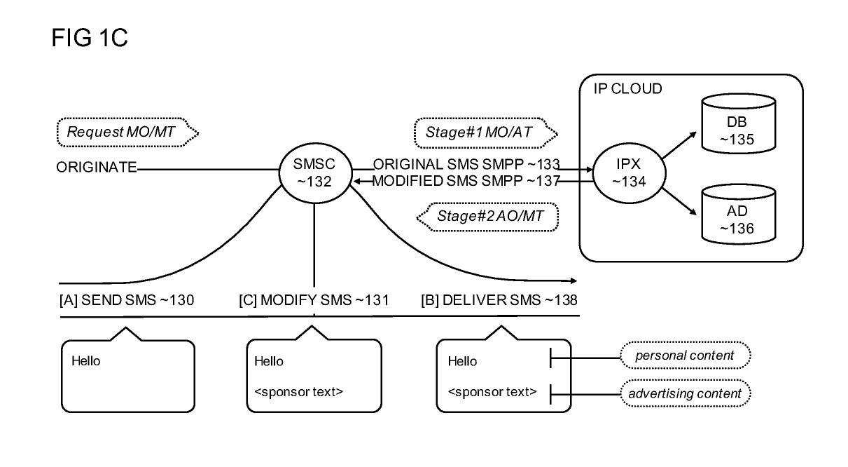

FIG. 1A: Describing the systems and methods in greater detail with reference to FIG. 1A and associated (˜XXX) numeric labels, the Original SMS message body is modified to accommodate Third Party Sponsored content as follows:
110: Mobile user A sends SMS addressed to mobile user B.
111: The original SMS body content is processed and modified as follows:

The SMS traverses the Mobile Network along the well known originating path, via well known network elements, including: from the originating device A, via a network base station (not shown) to which the device is wirelessly connected; from the network base station to the visited originating Mobile Switching Center (MSC not shown) to which the originating mobile station is logically attached; from the MSC to the Short Message Service Center (SMSC).
112: The SMSC receives the originating message request from the MSC. The SMSC and attendant nodes, analyze the original message (attendant nodes in the preferred embodiment, are described below in FIG. 1C). The original message is processed as follows:

Firstly, the message is selectively truncated to a maximum character length threshold in order to create the necessary space to append the third party content. That is, if the message length exceeds a maximum threshold, the threshold being a maximum number of characters permitted in the messagebody, as defined by the message protocol, the original message is truncated. In truncating the message, any additional character over and above the threshold count is typically discarded.

If the original message is truncated, in the preferred embodiment, the recipient may be alerted to the fact that the original message is not being presented in its entirety. Visually indicating message truncation may be achieved by displaying a character or sequence of characters at the end of the personal message. For example, without limitation, the service may indicate that the original message was truncated by ending the personal message portion of the modified message, with an ellipsis (“ . . . ”), star (“*”), slash (“/”) or similar. If the message length is below the specified threshold it is preserved in full, as originally constructed.

Secondly, third party contentis retrieved from an advertising platform (not shown) and appended to the original (truncated) message content. The original message is now modified and includes both the original (truncated) text together with third party text appended. In an alternate embodiment, when truncating the text, a copy of the original full text message is stored and referenced by the third party content appended. In such an embodiment, the third party content includes a URL referencing the stored text.
113: The modified SMS is forwarded by the SMSC for delivery to the destination device. The Store and Forward SMS delivery protocol is well understood.

FIG. 1B: Describing the systems and methods in greater detail with reference to FIG. 1B:
120: Mobile user A sends an SMS addressed to mobile User B.
121: The SMS is processed and modified as follows:

The SMS traverses the Mobile Network along the well known originating path, as described above, to the Short Message Service Center (SMSC).
122: The SMSC receives the originating message from the MSC. The SMSC and attendant nodes analyze the original message (attendant nodes in the preferred embodiment, are described below in FIG. 1C).
123: The original message is stored in Database (DB 123) for future reference. This database record captures the sender MSISDN A, the recipient MSISDN B and the original message content as constructed by the sender. In one embodiment, the database record is indexed on the recipient MSISDNB as the primary access key. It is important to understand the while DB is the primary store, the record may be replicated across additional database nodes. Consequently, record retrieval may be from an associated database rather than from this original database.

The original message is replaced with an Internet URL that references the said original message. Typically, the message is formatted to notify the recipient that a “New message” is awaiting retrieval at the associated link. The URL, in one embodiment, contains the mobile telephone number MSISDN B of the recipient to which the original message was addressed. This B mobile number is then utilized to access the Database to retrieve the original message content previously stored.

The modified SMS, which now comprises the notification and the said text link, is forwarded by the SMSC for delivery to the destination device B. Message delivery is well understood by mobile network artisans.
124: The destination mobile device receives the notification SMS containing the URL link which references the original message content.
125: On receiving the notification SMS at mobile device B, and upon the recipient activating the embedded ULR link, mobile device B is directed, via a browser on the device, to Web Server WWW 126.
126: The Internet Web Server retrieves the original message content and sender MSISDN A, from Database (DB 123) and any attendant nodes.
127: On rendering the page described by the URL to display the original message sender and content, the Internet Server links to Advertising Platform (AD 127) to access third party content (not shown). This third party content is rendered and displayed on device B in the browser, together with the original message content.

FIG. 1C: Describing the SMS Modification to the original content in greater detail with reference to FIG. 1C.

In one embodiment, the systems and methods disclosed are implemented on legacy (“closed”) SMSC nodes. In a preferred embodiment, the systems and methods are implemented by interconnecting legacy SMSC nodes to an open all IP architecture that seamlessly delivers the disclosed SMS modifications without any modification to legacy messaging infrastructure.

Short Message Peer to Peer (SMPP) is one such open, industry standard telecommunications interface and protocol, designed to provide a flexible data communication interface for the transfer of short message data between External Short Messaging Entities (ESME) and SMS Message Centers. SMPP is an IP protocol.

Utilizing the SMPP interface for the systems and methods disclosed, the Carrier simply routes all MO SMS messages destined for MT delivery, to the IP nodes for SMS content modification as taught. In one user invoked embodiment, this routing is achieved on the user addressing the SMS with a special routing prefix as disclosed above. In a prefix routing embodiment, SMS messages are thus differentially routed from regularly addressed SMS messages, on the said prefix.

In an alternate network invoked embodiment, routing SMS messages over the SMPP interface is readily achieved by specifying a wildcard routing entry in the SMSC routing tables, that reroutes all MT SMS messages to the attendant IP nodes for modification as taught. Wildcards are well understood by switching and routing artisans. In particular, since routing prioritizes more specific routing entries over less specific routing entries, wildcards can route all messages that are not explicitly matched to destinations enumerated in the message routing tables.

For example, SMS Short Codes are a common addressing schema that permits users to send SMS messages to Applications rather than to other mobile users. These SMS short codes are exceptioned from wildcard routing, since they are explicitly enumerated in the SMSC routing tables and are therefore routed in priority over less specific routing entries, which fail to precisely match any particulardefined short code.

By example, assuming a 3 digit (XXX) SMS Short Code, the routing entry stipulates that all messages addressed to such an XXX code, defined as a minimum and maximum of 3 digits, routes as a priority over messages sent to a mobile destination which for example, may be defined as typically having 10-15 digits in the address. Moreover, since SMS Short Code services are themselves distinct, each short code typically maps to its attending service platform.

In the disclosed Two Staged SMS delivery depicted in FIG. 1C, the original SMS message which is MO/MT (Mobile Originating and Mobile Terminating) is decoupled from the mobile destination and readdressed to route in two stages:

Stage #1: MO/AT. The MO SMS sent from user A now routes via the SMSC, over the SMPP interface as described above, to terminate at the IP node. This is termed AT (Application Terminating) routing herein. At this point in the SMS process, the SMSC has completed the original message delivery, albeit to an Application node rather than the intended mobile destination device B.

Stage #2: AO/MT. Once the attendant IP nodes have modified the original SMS content as taught, the Application Originates (termed AO herein) a second SMS transaction, where the modified SMS is now resubmitted to the SMSC, over the SMPP interface, to deliver and terminate at the originally specified destination device B.
130: Mobile user A sends an SMS addressed to mobile User B.

The SMS traverses the Mobile Network along the well known originating path, as described above, to the Short Message Service Center (SMSC).
131: The original message body content is modified as follows:
132: SMSC receives the originating message from the MSC.
133: The SMSC routes the SMS received over the SMPP interface to an attendant Application node (IPX 134).
134: Node IPX analyzes and modifies the original message as described above in FIG. 1A, where the SMS message is truncated and third party content is retrieved from Advertising Platform (AD 136) and appended to the message; and as in FIG. 1B, where the message is stored in a database (DB 135) for later retrieval via a URL embedded in the modified message.
137: The now modified SMS message, is resubmitted to the SMSC over the SMPP interface, for delivery to the original destination, mobile device B.
138: The modified SMS is forwarded by the SMSC for delivery to destination device B.

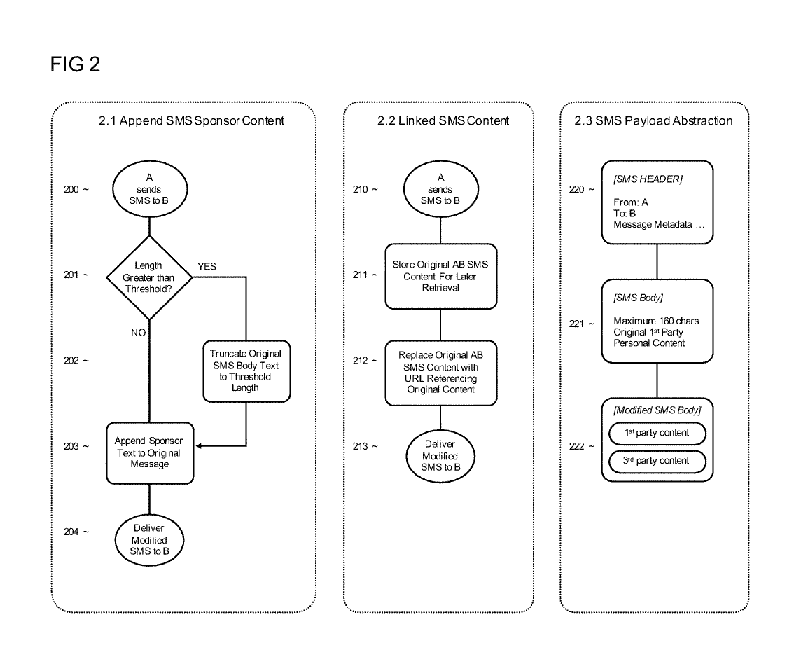

FIG. 2 (PANEL 1): Describing the logical steps performed in the SMS modification, where Third Party content is appended to the original message content, with reference to the first flowchart panel in FIG. 2.1:
200: Mobile user A sends an SMS addressed to mobile User B.

The SMS traverses the Mobile Network along the well known originating path, via well known network elements, including: from the originating device, via the network base station (not shown) to which the device is wirelessly connected, from the network base station to the servicing originating Mobile Switching Center (MSC not shown) to which the originating mobile station is attached, to the Short Message Service Center (SMSC).

The MSC forwards the originating message request to the SMSC. The SMSC and attendant nodes, analyze the original message.
201: If the original personal content in the message body is less than a predetermined maximum number of characters, control proceeds to Step 203.
202: The message is truncated to a maximum character length threshold. In truncating the message, any additional character over and above the threshold count is discarded.

In one embodiment, the recipient may be alerted to the fact that the original message has been truncated and is not being presented in its entirety, by displaying a character or sequence of characters to indicate the message has been trimmed. For example, without limitation, the service may indicate that the original message was truncated by ending the personal message portion of the modified message with an ellipsis (“ . . . ”), star (“*”), slash (“/”) or similar. If the message length is below the specified threshold, it is preserved in full as originally typed.
203: Third party content is retrieved from an advertising platform (not shown) and appended to the original (truncated) message content. The original message is now modified and includes both the original (truncated) text together with third party text appended.
204: The modified SMS is forwarded by the SMSC for delivery to the destination device. The Store and Forward SMS delivery protocol, as well as the message delivery process, is well understood.

FIG. 2 (PANEL 2): Describing the logical steps performed in the SMS modification, where the original message content is replaced with a link referencing the original content, with reference to the second flowchart panel in FIG. 2.2:
210: Mobile user A sends an SMS addressed to mobile User B.

The SMS traverses the Mobile Network toward the SMSC as described above.
211: The original SMSmessage content, together with the AB addressing information, is stored in a database (not shown) for future retrieval.
212: The original SMS content is replaced with a URL link referencing the original message content, now stored in the said database.
213: The SMS containing the URL referencing the original message content is forwarded by the SMSC for delivery to the destination device.

FIG. 2 (PANEL 3): Describing an abstracted view of the SMS payload with reference to the third panel in FIG. 2.3:
220: Depicts the SMS Header.

The SMS header contains messaging metadata. SMS header metadata includes addressing information (sending mobile MSISDN A, recipient MSISDN B, servicing SMSC point code address) together with message settings that describe and control message delivery (length of the message body content, message encoding, message validity and so on). Message header metadata is well documented and understood.
221: Depicts the SMS Body.

The SMS body is a logical and physical container that stores the original SMS message content as constructed by sender A. Typically the SMS body contains up to a maximum 160 characters of personal content.
222: Depicts the Modified SMS body as taught herein.

The original SMS body content has beenmodified to include Third Party content as described above. The resultant SMS body now comprises “1st party” personal message content from sender A, together with “3rd party” sponsored message content. The SMS header is updated to reflect the now modified message body.

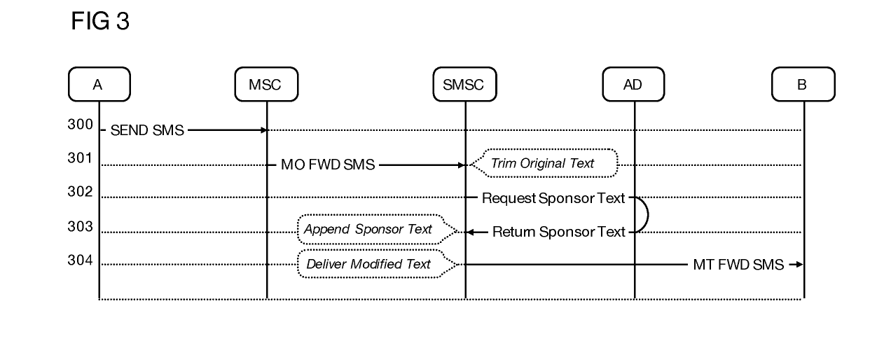

FIG. 3: Describing the SMS modification, where Third Party content is appended to the original message content, in further detail with reference to Step Ladder FIG. 3:
300: Mobile user A constructs and sends SMS message addressed to mobile User B.

The SMS traverses the Mobile Network along the well known originating path, via well known network elements, including: from the originating device A, over the air interface via the network base station to which the device is connected (not shown), from the network base station to the servicing originating Mobile Switching Center (MSC) to which the originating mobile station is attached, to the Short Message Service Center (SMSC). The transmission of the SMS from the originating device to the MSC over control channel signaling, is well understood.

The MSC receives the originating message request. The MSC and attendant nodes, including the VLR (Visitor Location Register) and AUC (Authentication Center), both not shown, perform any necessary verification and authentication that may be required to process the originating SMS request from mobile device A. SMS mobile originating verification and authentication processes are well understood.
301: The MSC forwards the SMS (Mobile Originating Forward Short Message) to the SMSC for processing and delivery. The SMSC and attendant nodes, selectively truncates the original SMS message content as described above if required. Attendant nodes in the preferred embodiment that utilize the SMPP interface are described above in FIG. 1C.
302: The SMSC and attendant nodes request third party sponsored message content from Advertising Server (AD). Protocols to query a remote server and database for content are well understood by networking and database artisans.
303: AD returns the requested third party content to the SMSC and attendant nodes. The third party content is appended to the original SMS content. The attendant nodes resubmit the modified SMS to the SMSC for delivery to the to the destination device MSISDN B.
304: The SMSC forwards (Mobile Terminating Forward Short Message) the now modified SMS, which contains both original personal content and third party sponsored content, to the destination mobile device B.

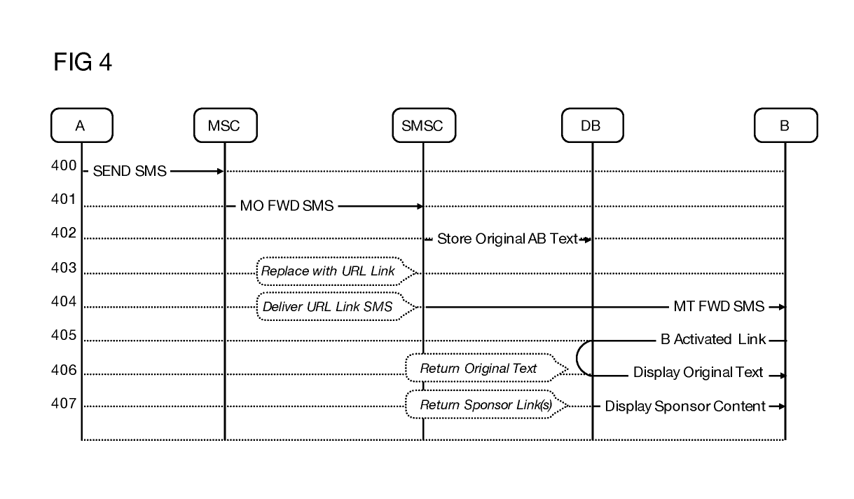

FIG. 4: Describing the SMS modification, where the original SMS content is replaced by a URL link referencing the original message content, in greater detail with reference to Step Ladder FIG. 4:
400: Mobile user A constructs and sends a mobile originating SMS addressed to mobile User B. The SMS traverses the Mobile Network as described above to the MSC.
401: The MSC performs any verification and authentication as may be required and forwards the SMS (Mobile Originating Forward Short Message) to the SMSC for processing and delivery. The SMSC and attendant nodes, truncates the original SMS message content as described above.
402: The SMSC and attendant nodes, stores the original SMS content and addressing information in Database DB as described in FIG. 1B above.
403: The SMSC and attendant nodes replaces the original SMS content with a URL link referencing the now stored original SMS message content. In one embodiment the link is formed as URL/B, and its variants as described above. In one embodiment the URL link may be constructed and returned by the DB on verifying that the SMS has been successfully stored. In an alternate embodiment the URL link may be constructed by the SMSC and attendant nodes. Attendant nodes in the preferred embodiment are described above in FIG. 1C.
404: The SMSC forwards (Mobile Terminating Forward Short Message) the now modified SMS, which contains the URL link referencing the original stored SMS message, to the destination mobile device B.
405: On activating the URL link contained in the received SMS, the B mobile device requests the referenced resource via WWW server (not shown). Links activated in an SMS message launches a browser application resident on the mobile device to render and display the referenced resources.
406: The browser connects to the WWW server at the domain described in the URL, retrieves the original SMS message from the DB store as described above, returns with the original SMS content and displays the content in the browser on the mobile device.
407: In addition to retrieving and returning the original SMS content, the WWW server references third party content via associated URLs. These third party links display sponsored content in the browser on the mobile device. Programming logic that supports accessing multiple resources on a single URL, using server side HTML, JavaScript and other Scripting Languages, is well understood. Multiple referenced resources may load substantially simultaneously in the browser.

The third party sponsored content may include stylized text, images, video and other richly formatted content. Since the original SMS message and third party content is now rendered and displayed in the mobile browser rather than the native SMS application, it is unconstrained in format.

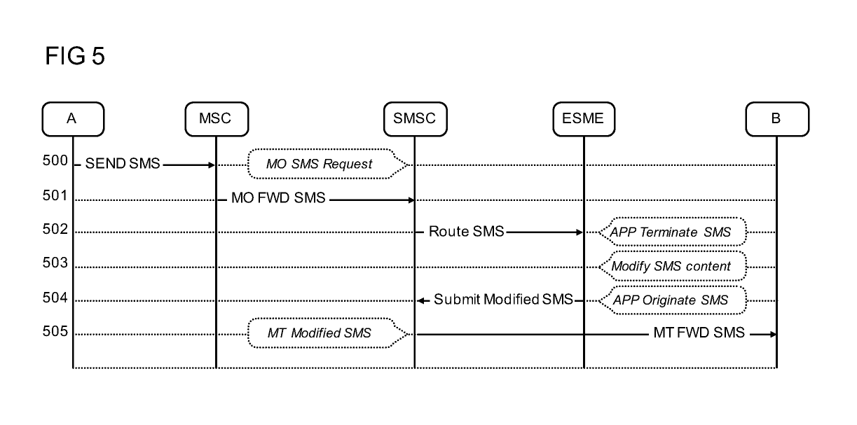

FIG. 5: Describing the preferred embodiment for SMS content modification via an External Short Message Entity with reference to Step Ladder FIG. 5:
500: Mobile user A constructs and sends a Mobile Originating SMS addressed to Mobile User B. The SMS traverses the Mobile Network, as described above, to the MSC.
501: The MSC performs any verification and authentication, as may be required, and forwards the SMS (Mobile Originating Forward Short Message) to the SMSC for processing and delivery.
502: The SMSC and attendant routing tables, routes the SMS to External Short Message Entity (ESME). SMS Wildcard and Prefix Routing logic is described above. ESME is an IP messaging Application node, and routing is over the SMPP or equivalent interface. This constitutes the First Stage Mobile Originating to Application Terminating (MO/AT) SMS phase as described in FIG. 1C.
503: ESME and attendant Database and Advertising Nodes (not shown) modifies the original SMS content as per the methods and systems disclosed herein.
504: ESME submits the now modified SMS content to the SMSC for delivery to the original B party recipient. This constitutes the Second Stage Application Originating Mobile Terminating (AO/MT) SMS phase as described in FIG. 1C.
505: SMSC forwards (Mobile Terminating Forward Short Message) the now modified SMS to the destination mobile device B. This completes SMS Mobile Termination.

What is claimed is:

1. A method for integrating third party sponsored content into a personal peer to peer wireless messaging service, comprising:
a) receiving at an intermediary network service node, a mobile originating message from a first user on a first telephony device, addressed to a second user on a second telephony device;
b) modifying the content of the original message;
c) sending the modified message to the second user on the second telephony device.

2. The method of claim 1, wherein modifying the original message content comprises changing the original text message content to include additional third party text.

3. The method of claim 1, wherein modifying the original message content comprises replacing the original text message content with an Internet uniform resource locator (URL) referencing the original text content.

4. The method of claim 1, wherein receiving the mobile originating message is received at no cost; or at a discounted cost to the sender relative to a message sent without any third party content.

5. The method of claim 1, wherein modifying the content of the original message applies a charge to the third party referenced in the modified content.

6. The method of claim 1, wherein the wireless message is an SMS text message.

7. The method of claim 1, wherein the wireless message is an MMS multimedia message.

8. The method of claim 1, wherein the network invokes the message content modification for all mobile terminating messages.

9. The method of claim 1, wherein the user invokes the message content modification, on prefixing the B party address with a requisite service symbol or code.

10. The method of claim 8, wherein the user signals the wireless messing service to suppress message content modification, on prefixing the B party address with a requisite symbol or code.

11. A system for integrating third party sponsored content into a personal peer to peer wireless messaging service, comprising a processor and a non-transitory computer readable medium having instructions stored thereon, that when executed cause the processor to:
a) receive at an intermediary network service node, a mobile originating message from a first user on a first telephony device, addressed to a second user on a second telephony device;
b) modify the content of the original message; and
c) send the modified message to the second user on the second telephony device.

12. The system of claim 11, wherein modifying the original message content comprises changing the original text message content to include additional third party text.

13. The system of claim 11, wherein modifying the original message content comprises replacing the original text message content with an Internet uniform resource locator (URL) referencing the original text content.

14. The system of claim 11, wherein receiving the mobile originating message is received at no cost to the sender; or at a discounted cost to the sender relative to a message sent without any modified content to the original message.

15. The system of claim 11, wherein modifying the mobile originated content applies a charge to the third party referenced in the modified content.

16. The system of claim 11, wherein the wireless message is an SMS text message.

17. The system of claim 11, wherein the wireless message is an MMS multimedia message.

18. The system of claim 11, wherein the system invokes the message content modification for all mobile terminating messages.

19. The system of claim 11, wherein the user invokes the message content modification, on prefixing the B party address with a requisite service symbol or code.

20. The system of claim 18, wherein system is configured to suppress message content modification, when the user prefixes the B party address with a requisite symbol or code.
